(19) United States
(12) Patent Application Publication
(10) Pub. No.: US 2005/0127239 A1
(43) Pub. Date: Jun. 16, 2005

(54) Flying work station

(76) Inventor: Varad Narayan Srivastava, Ann Arbor, MI (US)

Correspondence Address: Kenneth I. Kohn;KOHN & ASSOCIATES, PLLC, Suite 410, 30500 Northwestern Highway, Farmington Hills, MI, 48334, US

(21) Appl. No.: 10/926,156

(22) Filed: Aug. 25, 2004

Related U.S. Application Data
(60) Provisional application No. 60/498,081, filed on Aug. 25, 2003.

(51) Int. Cl. B64C 15/00

(52) U.S. Cl. 244/12.2

(57) ABSTRACT

A flying work station including a body portion and vertical lifting devices for providing vertical force to the body portion. Further, the flying work station can include lateral directing devices for providing lateral directional forces to the body portion in addition to stability devices for providing stability and balance to the body portion.

### CROSS-REFERENCE TO RELATED APPLICATIONS

This application claims the benefit of priority under 35 U.S.C. Section 119(e) of U.S. Provisional Patent Application No. 60/498,081, filed Aug. 25, 2003, which is incorporated herein by reference.

### BACKGROUND OF THE INVENTION

1. Field of the Invention

Generally, the present invention relates to a flying workstation. More specifically, the present invention relates to a flying workstation capable of holding a human.

2. Description of the Related Art

Coaxial helicopters were first developed, in the form of small devices used as toys and curiosities, centuries ago. The earliest attempts at designing a practical helicopter focused on coaxial rotors and dual counter-rotating arrangements. Later, conventional helicopter designs were developed. These were single-rotor helicopters. These helicopters needed a long tail boom having a tail rotor at the end rotating in a plane roughly perpendicular to the plane of rotation of the main rotor in order to consistently apply a reaction moment to prevent the airframe of the helicopter from uncontrollably rotating in a direction opposite that of the rotor. The need for a tail rotor has provided the readily recognized shape of conventional single-rotor helicopters.

It was theorized and proven that a helicopter with two counter-rotating rotors could be built such that the rotational force of one rotor counteracts the rotational reaction force of the other, leaving the helicopter body stable without the need for a perpendicularly acting tail rotor. The first controllable man-carrying helicopters were tandem-rotor designs, while the second were dual, coaxial rotor helicopters. Tandem-rotor helicopters, however, remain the most common dual-rotor helicopters.

Tandem-rotor helicopters can be useful for heavy lifting operations where a large payload capacity is needed. Conventional tandem-rotor helicopters typically have an elongate body with a first rotor atop the front end and a second rotor atop the rear end. The rotors can be elevationally offset so as to avoid contact with each other when rotating, or the rotors can be separated by a sufficient distance to prevent contact.

On the other hand, dual, coaxial rotor helicopters have also been developed. These helicopters include two counter-rotating rotors mounted on a single axis. While coaxial helicopters have been known for many years, development of this type of aircraft has been limited because of complexities involved in arrangements for control of the rotor blades to give roll, pitch, and yaw control.

In conventional dual, coaxial rotor designs, at least two swash plate assemblies are provided. A substantially conventional swash plate is provided below a lower rotor; and a swash plate assembly incorporating two counter-rotating swash plate portions is provided between the upper and lower rotors. Associated control links, push rods, etc., are needed so that cyclic and collective pitch control inputs to the upper rotor can be transferred past the counter-rotating lower rotor. As is known, using this arrangement it is a daunting task to provide a reliable aircraft without unduly burdensome maintenance requirements. The control arrangements are necessarily complex because the swash plate assemblies and control links must transfer relatively high forces. Thus, the swash plate assemblies and control links are robust and heavy.

All aircraft, helicopters included, require control of attitude (including pitch, roll, and yaw), and linear motion (speed). The main rotor of a conventional single-rotor helicopter is typically configured to vary the pitch of the rotor blades cyclically and/or collectively to control pitch, roll, and lift, and therefore forward, reverse, or side-to-side motion. Collective blade pitch control of the tail rotor controls yaw. The power output of the engine can also be varied, albeit within a fairly narrow operational power band, and this can affect lift and yaw.

In conventional tandem-rotor and dual, coaxial rotor helicopters, these same attitude and lift controls are affected by cyclic and/or collective pitch variation of the blades of both rotors. Yaw control is by differential collective control inputs to the counter-rotating rotors, causing one to have more drag and the other less, thereby turning the aircraft about the yaw axis.

Coaxial helicopters potentially present many advantages over conventional single-rotor and tandem-rotor helicopter designs. The designs can be more compact than a single-rotor design because of higher disk loading and the designs have no need for a tail rotor for counter-acting the tendency of the airframe to turn around the rotor axis. Coaxial designs are more compact than a tandem design because there is no need to separate the rotors except for vertical rotor clearance. Because of the higher disk loading, coaxial designs can provide a given desired lifting force using a smaller diameter rotor set than comparable single-rotor helicopters. The designs require a smaller airframe than a comparable tandem-rotor helicopter. Moreover, because the rotors of a coaxial helicopter are disposed one on top of the other and are counter-rotating, power efficiency losses due to vortex air movement adjacent the upper rotor can be at least partially recovered in increased effective airspeed and lift in the lower rotor. In other words, the upper rotor forces the air in one direction, and the lower rotor forces the air in the other direction, which results in canceling each other out. Also, elimination of the tail rotor frees up the engine power otherwise diverted there. The savings has been cited as up to about thirty percent of total engine power in some cases.

However, as noted above, there is a trade-off for these advantages in that providing for the control of coaxial rotor helicopters presents additional complexities with regard to weight and maintenance concerns. One approach to mitigating the disadvantages of a coaxial arrangement is to eliminate the need for swash plates and complex control linkages altogether. Rather than adjusting the pitch of the coaxial rotor blades, an alternative for controlling coaxial helicopters is to make the axis of rotation of the coaxial rotor set tiltable with respect to the airframe, allowing pitch and roll control by effectively shifting the center of weight of the aircraft with respect to the thrust vector of the coaxial rotor set. Such a system is disclosed, for example, in U.S. Pat. No. 5,791,592 to Nolan, et al. In the system disclosed in the Nolan, et al. patent, there is no need for cyclic blade pitch control and there is no collective pitch control. Tilt of the coaxial rotor set and increasing or decreasing the speed of the rotors, provides pitch, roll and lift control. Since, the disk loading in coaxial helicopters is higher and rotor diameter is smaller than conventional designs, adequate control of lift is possible without collective blade pitch control, though some lag in response is deemed inherent and should be taken into account by a pilot operating a helicopter of this design.

In order to overcome many of these problems, individuals of skill in the art have developed a number of “flying platforms” including vertical take-off and landing (VTOL) devices. There are generally three types of vertical take-off and landing (VTOL) configurations under current development, a wing type configuration (a fuselage with rotatable wings and engines or fixed wings with vectored thrust engines for vertical and horizontal national flight), helicopter type configuration (a fuselage with a rotor mounted above which provides lift and thrust), and a ducted type configuration (a fuselage with a ducted rotor system, which provides translational flight, as well as vertical take-off and landing capabilities).

Other than the electric motor tethered AROD, all past VTOLs, manned or unmanned, have dealt with loud, heavy fuel burning engines as the means of propulsion. Flight vehicles of this type are known, utilizing either fuel powered rocket-boosters, fuel-powered gas turbine engines or fuel-powered gasoline or diesel engines. In the case of rocket engines and gas turbine engines, jets are directed in a downward direction so that the hot gases therefore represent a danger. This is not only a risk to the pilot, but it also might ignite inflammable materials on the ground, such as dry grass and shrubbery. Additionally, the high temperature of these gases places a restriction on the choice of materials used in the construction of the flight vehicle. For example, plastics and aluminum cannot be used for components exposed to hot exhaust gases.

Accordingly, there is a need for a flight vehicle that is stable and lightweight and capable of resolving the above problems.

### SUMMARY OF THE INVENTION

According to the present invention, there is provided a flying work station including a body portion and vertical lifting devices for providing vertical force to the body portion. Further, the flying work station can include lateral directing devices for providing lateral directional forces to the body portion and stability devices for providing stability and balance to the body portion.

### DESCRIPTION OF THE DRAWINGS

Other advantages of the present invention are readily appreciated as the same becomes better understood by reference to the following detailed description, when considered in connection with the accompanying drawings wherein:

FIG. 1 is a top, perspective view of an embodiment of the flying work station of the present invention;

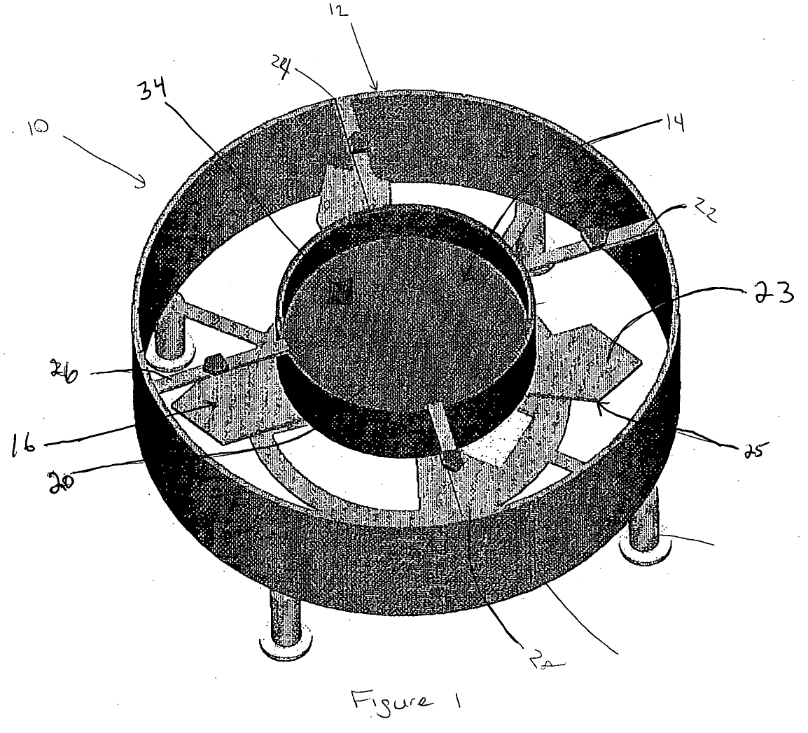

FIG. 2 is a bottom, perspective view of an embodiment of the flying work station of the present invention;

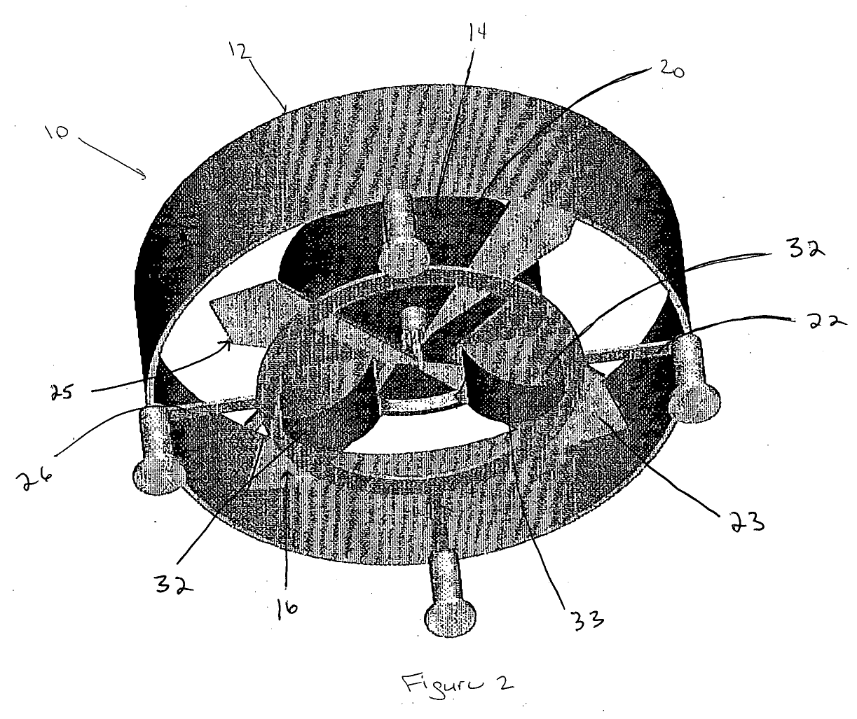

FIG. 3 is a top view of an embodiment of the flying work station of the present invention;

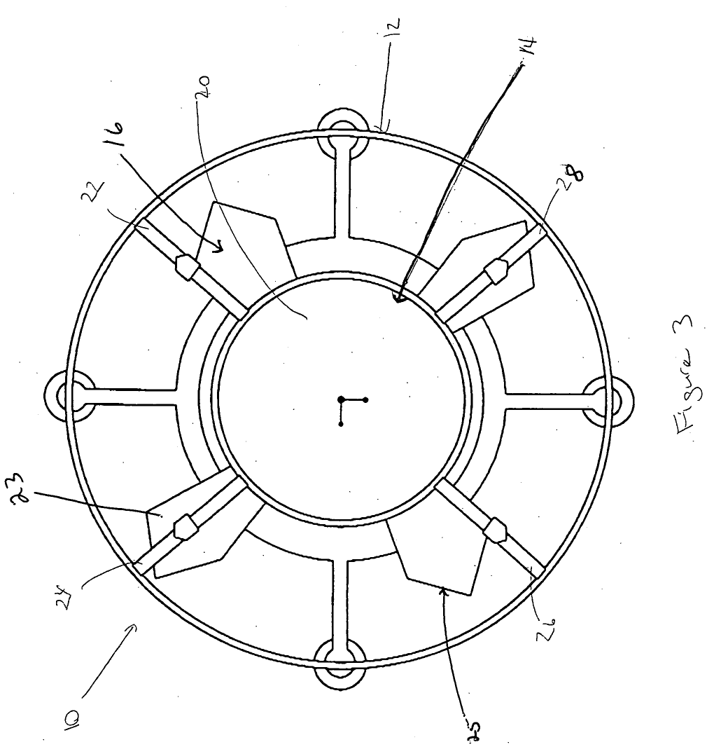

FIG. 4 is a right-hand side view of an embodiment of the flying work station of the present invention;

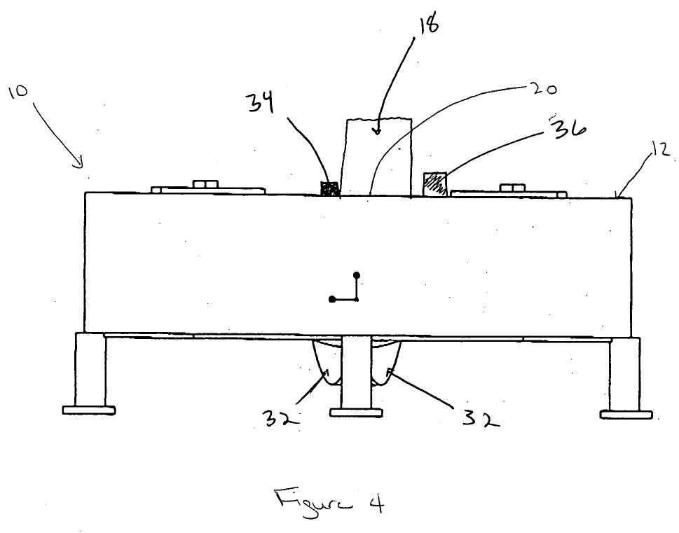

FIG. 5 is a front view of an embodiment of the flying work station of the present invention; and

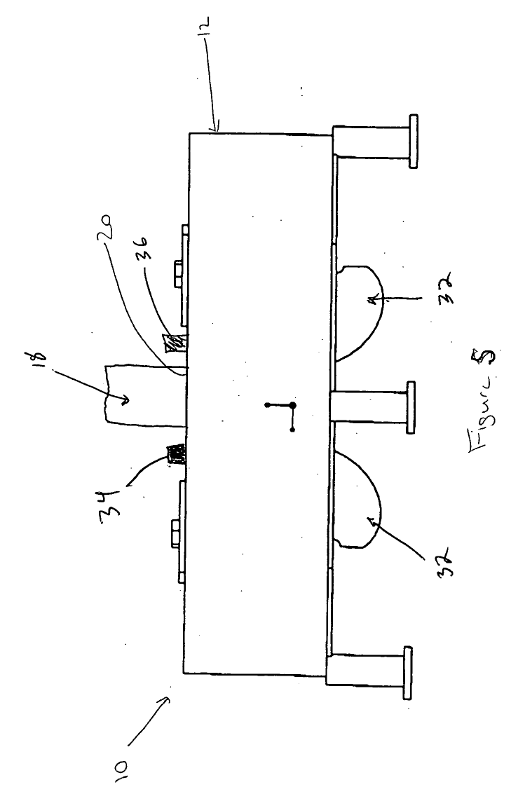

FIG. 6 is a bottom view of an embodiment of the flying work station of the present invention.

### DETAILED DESCRIPTION OF THE INVENTION

Generally, the present invention provides a flying work station, generally shown as 10 in the figures.

The present invention has numerous advantages over the prior art. First, with the present invention, the operator himself or herself is not used for motion and control of the craft. This greatly increases the stability of the flying work station 10. Second, the present invention can utilize devices that vector air in a plane parallel to the ground based on the desired operational requirements. This overcomes issues of stability in takeoff and landing, as is the case with all conventional rotorcrafts and helicopters. Further, these devices provide lateral forces that can be used to steer or direct the flying work station 10. Third, the present invention utilizes a specific system for stability, which is a system of weights controlled by at least one gyroscope. This added dynamic stability is an improvement over the prior art. The present invention is different from previous designs in the prior art because it provides controlled inputs to the flying work station 10 without depending directly on the operator's motion. This is important if the operator is to accomplish a task while flying the work station. Also, the present invention has shrouded rotors; therefore, it allows for closer access to buildings and safer operation in public areas as opposed to a conventional helicopter. This shrouded system provides opportunities for noise reduction, thereby increasing its appeal for use in an urban setting. Therefore, the combination of all these elements provides an improvement over the prior art.

The flying work station 10 of the present invention and its various components are made from lightweight and durable materials including, but not limited to, composite materials, metals, alloys, harden polymers, carbons, combinations thereof, and any other similar lightweight and durable material known to those of skill in the art. Moreover, the various components of the flying work station 10 are permanently or removably joined, attached, and/or connected together utilizing devices including, but not limited to, screws, nails, bolts, weldable devices, and other fixing devices known to those of skill in the art. Finally, various components of the present invention are controlled via switches, levers, and/or controls well known to those of skill in the art. These switches, levers, and/or controls can be electrically wired or are wirelessly connected to each of the various components located throughout the flying work station 10 of the present invention to provide control thereof.

Generally, the flying work station 10 includes a body portion 12 having a base area 14 and lifting devices 16. Further, the flying work station 10 can include lateral directing devices 32 for providing lateral directional forces to the body portion 12 and stability devices 34 for providing stability and balance to the body portion 12.

The body portion 12 is generally circular in shape, as shown in the Figures. However, any appropriate shape can be utilized or desired. The body portion 12 includes a base area 14 centrally located within the body portion 12. The base area 14 can optionally include a seat 18 fixably attached to a seating area 20. The seat 18 can be any seating device known to those of skill in the art capable of being fixably attached to the seating area 20. For example, the seat 18 can be a chair or other seat that is capable of being affixed to the flying work station 10 of the present invention. The seat 18 is affixed using devices capable of permanently or removably affixing the seat to the seating area 20 of the flying work station 10. Additionally, the seating area 20 can be optionally enclosed.

The base area 14 is maintained in position within the body portion 12 by at least four arms 22, 24, 26, and 28. The arms 22, 24, 26, and 28 are preferably all equally sized so as to maintain the base area 14 in the center of the body portion 12. The arms 22, 24, 26, and 28 can be either formed as a single unit with the body portion 12 or the arms 22, 24, 26, and 28 can be separately formed and affixed to the body portion 12 and base area 14 using affixing devices or affixing methods known to those of skill in the art. The arms 22, 24, 26, and 28 are preferably formed of the same material as the body portion 12. However, the arms 22, 24, 26, and 28 can be formed of a different material that can be rigidly affixed to the body portion 12.

The seating area 20 is a platform that is formed of a material capable of maintaining a seat 18 in place in the flying work station 10 of the present invention. The seating area 20 can be formed as a solid piece of material or it can be formed to include holes therein, such as venting holes or perforations that do not impact the functionality of the seating area 20, but increase the aerodynamics of the flying work station 10 by limiting the weight of the flying work station 10. Such similar designs can also be utilized with other components of the flying work station 10. The seating area 20 is preferably formed of a lightweight durable material.

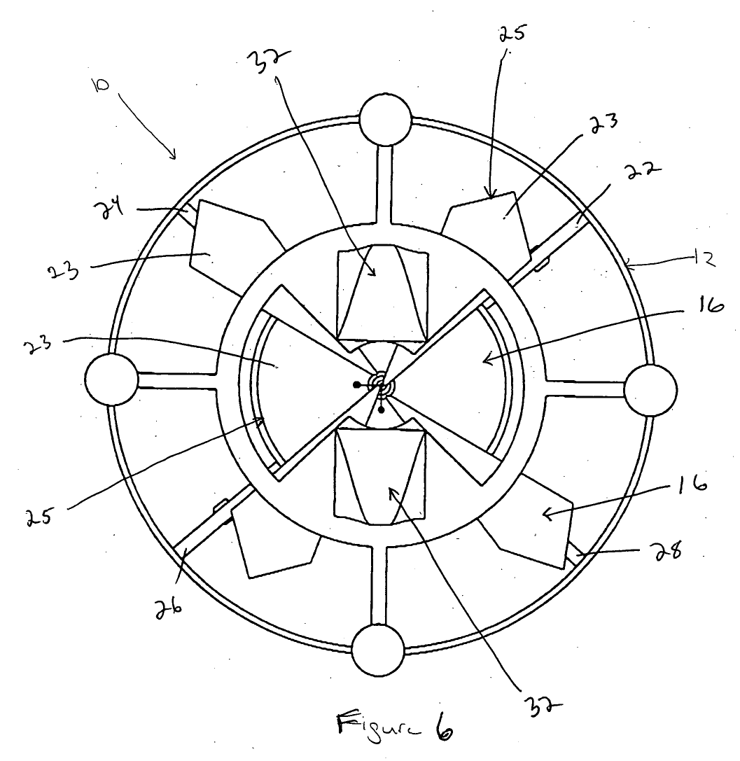

The lifting devices 16 of the present invention are rotors 23. The rotors 23 are configured to both lift the flying work station 10 and maintain the flying work station 10 in a level position such that a person sitting in the seating area 20 does not fall out of the flying work station 14. Preferably, the device of the present invention includes two, co-axial rotors 23 placed below the body portion 12 of the flying work station 10 to lift the structure. The co-axial rotors 23 are placed below the body portion 12 of the flying work station 10 to provide lift to the structure. An operator can be seated in the seating area 20, which is located coaxially above the rotors 23. Each rotor 23 includes at least two blades 25 for moving air. The blades 25 are made of materials well known to those of skill in the art. As set forth above, such materials include, but are not limited to, composite materials, metals, alloys, harden polymers, carbons, combinations thereof, and any other similar lightweight and durable material known to those of skill in the art. Each rotor 23 can be of similar size, shape, and design as is well known to those of skill in the art. Alternatively, each rotor 23 can vary and differ in size, shape, and design, as is well known to those of skill in the art and as determined by various design requirements (See, FIG. 6). Finally, the rotors 23 are shrouded by materials well known to those of skill in the art. Each rotor 23 can be individually shrouded or the entire rotor system can be shrouded. The design and shapes of the shrouding material depend upon desired requirements such as weight, available space on body portion 12, and aerodynamics.

The rotors 23 are driven by at least one engine well known to those of skill in the art. The engine can be an electric, turbine, and/or a combustion-type engine, depending upon the desired requirements. Such types of engines are well known to those of skill in the art. Further, placement of the engine depends upon desired requirements. Alternatively, more than one engine can be used to provide power needed so as to accommodate the failure of one engine.

The center of gravity of the flying work station 10 is at a minimal distance above the plane of lift. This can be achieved by making sure the rotors 23 are inclined with the horizontal. In a preferred embodiment, the operator is seated and that further decreases the center of gravity as compared to devices disclosed in the prior art. Further, as set forth above, the rotors 23 can be safely isolated and shrouded from any other portion of the seating area 20 via wire meshing, perforated metal sheets, solid structures, and any other similar enclosing devices known to those of skill in the art.

Balancing of the entire flying station 10 is achieved with the help of coaxial counter rotating shafts and blades 25 and by stabilizing devices 34. The second set of rotors 23 helps provide extra lift and balancing torque at the same time. Typically, the second set of rotors 23 is smaller in diameter than the first set of rotors 23, which provide the majority of the lifting force for the platform 10. The pressure built up due to the counter-rotating rotor 23 can be used for lateral motion. Alternatively, a tail fan 30 can be provided instead of a coaxial rotorcraft design. This would provide the adequate counter-torque required to balance the platform 10 of the present invention.

In order to provide lateral movement, lateral directing devices 32 can be utilized. The lateral directing devices 32 are structures located below the co-axial rotors 23 and direct pressurized air generated by the co-axial rotors 23 as they rotate. The lateral directing devices 32 direct and force the pressurized air in a plane parallel to the ground. As a result, the vectored air provides lateral forces to produce lateral movement of the flying work station 10. The lateral directing devices 32 are structures including, but not limited to, ducts, channels, tubular structures, wings, and any other similar structures known to those of skill in the art. The size and shape of the lateral directing devices 32 depend upon desired design requirements known to those of skill in the art. Moreover, the lateral directing devices 32 are adjustable in numerous ways. For example, the lateral directing devices 32 can also be adjusted by either partial or complete rotation thereof or by adjusting the opening of the lateral directing devices 32 through adjustable flaps 33 or panels. Preferably, there are at least two lateral directing devices 23 complementary to each other under the base area 14 of the flying work station 10. Further, these lateral directing devices 32, as with all other devices located on the platform 10, are controlled by switches and levers known to those of skill in the art.

In a preferred embodiment, two ducts 32 use the pressurized air produced by two rotors 23 and channel the air to propel the flying work station 10. Downwash from the rotors 23 is forced into the ducts 32 immediately below the rotors 23. The ducts 32 can be individually rotated at least 180 degrees to provide two force vectors that can be used to provide forward, sideways motion. Alternatively, the ducts 32 can be rotated to cancel each other out to allow hovering. Lateral motion is achieved by using the pressurized air from the rotors 23 and does not require any extra energy. Also, downwash during take-off and landing does not pose any additional problems since downwash from the rotors 23 is directed. In fact, the enclosed area other than the two duct outlets 32 increases lift and efficiency due to the ground effect. This means a potential reduction in rotor diameter and increased fuel efficiency. No additional power is being used for maneuverability. The dimensions and shape of these ducts 32 are critical to allow the minimum restriction of flow and pressure build-up at the inlet and achieve maximum pressure at the outlet of the ducts 32. The outer casing of the ducted fan can be given an airfoil shape. This ensures additional lift for the flying work station 10 when in motion.

The flying work station 10 is further stabilized by stability devices 34 including, but not limited to, at least one gyroscope. Gyroscopes 34 are well known to those of skill in the art. The gyroscope's 34 motion is not dependent on the operator's position. This is different from the old concepts and drastically reduces chances of operator error and enhances handling characteristics. As used herein, a gyroscope is a wheel or disk mounted to spin rapidly about an axis and also free to rotate about one or both of two axes perpendicular to ach other and to the axis of spin so that a rotation of one of the two mutually perpendicular axes results from application of torque to the other when the wheel is spinning and so that the entire apparatus offers considerable opposition depending on the angular momentum to any torque that would change direction of the axis of spin.

Any combination of gyroscopes 34 can be used. For example, a set of four gyroscopes 34 can be used. Alternatively, the gyroscopes 34 can be connected to a series of weights 36 and/or counter balances known to those of skill in the art. These weights 36 can be added to the body portion 12 of the flying work station 10 or the weights can be inherent components of the flying work station 10 itself. For example, the inherent components can be the control boxes, gear boxes, fuel tanks, and the like. With the use of the stability devices 34 and dual, coaxial rotors, balancing is achieved by the present invention independent of the operator's weight shifting.

Gyroscopes 34 allow the flying work station 10 to stabilize itself by altering the center of gravity using a system of weights 36. For example, gyroscopes 34 located in the seating area 20 provide a signal to actuate the appropriate system of weights 36 so that the weights 36 shift to negate any imbalance to the flying work station 10. Operator inputs or control system can also be incorporated into flying work station 10, thereby allowing the operator to define the direction and speed of travel. The control system then uses the system of weights 36 to alter the center of gravity to obtain the desired result. Imbalances and wind gusts are then treated as ‘noise’ (or undesirable inputs) in the control system and the gyroscopes 34 maintain the preferred direction and speed of travel. In addition to the gyroscopes 34, the ducts 32, which use downwash from the rotors 23 can also be used for a slower speed of travel. These can be especially useful for yaw control and moving/hovering purposes at a constant altitude.

The present invention specifically deals with unbalance due to gusts of wind, fuel displacement, and unforeseen forces by several weights 36 with gyroscopes 34. In one embodiment, at least four weights 36 slide along rails located on either the top or bottom of the flying work station 10 if control boxes or additional weights 36 are added to the flying work station 10 specifically for control. Displacement of the gear box or other inherent parts of the flying work station 10 to alter the center of gravity of the flying work station is also considered. Gyroscopes 34 onboard primarily control these weights. Operator input can also be incorporated into the system 10. This ensures that the flying work station 10 remains stable and can easily handle displacing forces. Further, the weights 36 can be utilized for fast and quick change of directions helping balancing motion during such maneuvers.

In other embodiments of the present invention, an ejection seat 18 can be included. Since the blades 25 are located below the pilot, an ejection seat 18 would be preferred. Another alternative design would utilize a commercial parachute for light aircraft.

The present invention has numerous uses and can be used in numerous settings. The present invention can be used to transport individuals, supplies, and other cargo where smaller and lightweight aerial rotorcraft are required. For example, the present invention can be used for fighting fires in high-rise buildings. Further, the present invention can be used as independent secure platforms for national security and military infantry in combat. In addition, the present invention can be used in a recreational setting.

Throughout this application, author and year and patents by number reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

1. A flying work station comprising:
a body portion;
vertical lifting means for providing vertical force to said body portion,
wherein said vertical lifting means is affixed to said body portion;
lateral directing means attached to said body portion for providing lateral directional forces to said body portion; and
stability means attached to said body portion for providing stability and balance to said body portion.

2. The flying work platform according to claim 1, wherein said body portion includes a seating area further including seating means for seating at least one individual.

3. The flying work platform according to claim 1, wherein said vertical lifting means is at least two rotors, wherein said rotors provide vertical lift to the flying work platform and maintains the flying work platform in a level position by providing balancing torque.

4. The flying work platform according to claim 3, wherein said rotors are co-axially placed below said body portion.

5. The flying work platform according to claim 1, wherein said lateral directing means is a structure selected from the group consisting of a duct, a channel, a tube, and a wing, wherein said lateral directing means directs pressurized air generated by said rotors and directs the air in a plane parallel to the ground.

6. The flying work platform according to claim 1, wherein said stabilizing means is at least one gyroscope.
